(19) United States
(12) Patent Application Publication
(10) Pub. No.: US 2016/0295044 A1
(43) Pub. Date: Oct. 6, 2016

(54) IMAGE FORMING APPARATUS

(71) Applicant: KYOCERA Document Solutions Inc., Osaka (JP)

(72) Inventor: Shigeaki Nakamura, Osaka (JP)

(21) Appl. No.: 15/085,242

(22) Filed: Mar. 30, 2016

(30) Foreign Application Priority Data
Mar. 31, 2015 (JP) 2015-071040

(51) Int. Cl. H04N 1/00; G03G 15/00; H04N 1/06

(52) U.S. Cl. CPC H04N 1/00708; H04N 1/0032; H04N 1/00795; H04N 1/06; H04N 1/00411; G03G 15/6529; H04N 2201/0094

(57) ABSTRACT

An image forming apparatus includes a sheet size sensing portion, an image forming portion, a registered condition information acquisition portion, and a printing control portion. The sheet size sensing portion senses the size of a sheet material in a sheet receptacle. The registered condition information acquisition portion acquires registered condition information representing the correspondence relationship between the size of the sheet material and a printing condition. The printing control portion causes the image forming portion to execute a printing process in accordance with the printing condition corresponding to the size sensed by the sheet size sensing portion in the registered condition information.

### INCORPORATION BY REFERENCE

This application is based upon and claims the benefit of priority from the corresponding Japanese Patent Application No. 2015-071040 filed on Mar. 31, 2015, the entire contents of which are incorporated herein by reference.

### BACKGROUND

The present disclosure relates to an image forming apparatus.

Generally, an image forming apparatus including a manual sheet-feed tray is known. The manual sheet-feed tray is one example of a sheet receptacle on which a sheet material to be fed to an image forming portion is placed. The sheet material is an image formation medium such as paper.

The sheet material that is frequently used is often housed within the sheet receptacle inside a cassette-type sheet feeding portion capable of housing a large number of sheets. On the other hand, various types of the sheet material depending on the needs are to be placed on the manual sheet-feed tray.

Furthermore, in a process of copying a document sheet image, the image forming apparatus that enables, through a key operation, selection of the type of a paper sheet to be used for copying a designated page is known.

### SUMMARY

An image forming apparatus according to one aspect of the present disclosure includes a sheet size sensing portion, an image forming portion, a registered condition information acquisition portion, and a printing control portion. The sheet size sensing portion is configured to sense the size of a sheet material placed on a sheet receptacle. The image forming portion is configured to execute a printing process of forming an image on the sheet material fed from the sheet receptacle. The registered condition information acquisition portion is configured to acquire registered condition information from a non-transitory computer-readable first storage portion configured to store the registered condition information in advance. The registered condition information is information representing a correspondence relationship between the size of the sheet material and a printing condition. The printing control portion is configured to cause the image forming portion to execute the printing process in accordance with the printing condition corresponding to the size sensed by the sheet size sensing portion in the registered condition information.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a configuration diagram of an image forming apparatus according to a first embodiment.

FIG. 2 is a block diagram of control-related portions included in the image forming apparatus according to the first embodiment.

FIG. 3 is a flowchart representing one example of procedural steps of a manual sheet-feed printing control in the image forming apparatus according to the first embodiment.

FIG. 4 is a data organization view of registered user information referred to by the image forming apparatus according to the first embodiment.

FIG. 5A is a data organization view of one part of registered condition information referred to by the image forming apparatus according to the first embodiment.

FIG. 5B is a data organization view of another part of the registered condition information referred to by the image forming apparatus according to the first embodiment.

FIG. 6 is a block diagram of control-related portions included in the image forming apparatus according to a second embodiment.

FIG. 7 is a flowchart representing one example of procedural steps of the manual sheet-feed printing control in the image forming apparatus according to the second embodiment.

FIG. 8 is a flowchart representing one example of procedural steps of a valid period determination process in the image forming apparatus according to the second embodiment.

FIG. 9 is a data organization view of valid period information referred to by image forming apparatus according to the second embodiment.

### DETAILED DESCRIPTION

Hereinafter, embodiments of the present disclosure will be described with reference to the accompanying drawings. The following embodiments are examples embodying the present disclosure and, by nature, do not limit the technical scope of the present disclosure.

### First Embodiment

An image forming apparatus 10 according to the first embodiment includes the function of a copy machine. For example, the image forming apparatus 10 is conceivably a multifunctional peripheral including the respective functions of a printer, a copy machine, and a scanner. In addition, the image forming apparatus 10 conceivably also includes a facsimile communication function.

The image forming apparatus 10, which functions as the copy machine, reads an image on a document sheet 90, and executes a copy job of forming an image of the document sheet 90 on a sheet material 9. The copy job is a job accepted by the image forming apparatus 10 in response to a user operation, and is one example of a job related to image formation. The sheet material 9 is a sheet-like image formation medium such as paper, coated paper, a postcard, an envelope, and an OHP sheet.

In addition, the image forming apparatus 10, which functions as the printer, forms, on the sheet material 9, an image represented in a print job received from a not-shown information processing apparatus.

[Configuration of Image Forming Apparatus 10]

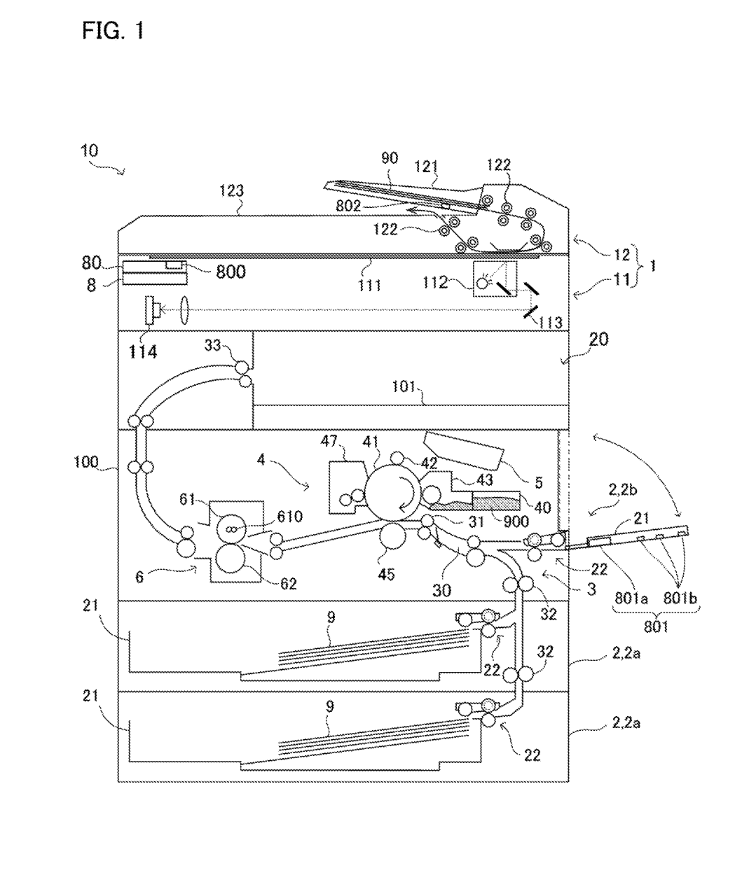

First, the overall configuration of the image forming apparatus 10 will be described with reference to FIG. 1. As shown in FIG. 1, the image forming apparatus 10 includes a plurality of sheet feeding portions 2, a sheet conveying portion 3, an image forming portion 4, a light scanning portion 5, a fixing portion 6, a control portion 8, and an operation display portion 80, etc. The image forming portion 4, the light scanning portion 5, and the fixing portion 6 execute an electrophotographic type printing process.

Furthermore, the image forming apparatus 10 also includes a document sheet conveying/reading portion 1. The document sheet conveying/reading portion 1 includes an image reading portion 11 and an ADF (Auto Document Feeder) 12. The image reading portion 11 includes a document sheet table 111, a reading unit 112, an optical system 113 such as mirrors and lenses, and an image sensor 114.

The document sheet table 111 is a part where the document sheet 90 is placed, and is provided on the upper surface of the image reading portion 11. The reading unit 112 emits light on the document sheet 90 placed at a reading position on the document sheet table 111, and reflects light that reflected therefrom toward the optical system 113. The reading unit 112 can move in a sub-scanning direction. It should be noted that the sub-scanning direction is a direction toward the right and left in FIG. 1.

The optical system 113 guides the reflected light from the document sheet 90 to the image sensor 114. The image sensor 114 includes a photoelectric conversion element or the like, and outputs, to the control portion 8, electrical signals in accordance with the amount of received light as image data representing the image of the document sheet 90.

The ADF 12 includes a plurality of conveying rollers 122 for conveying the document sheet 90, and conveys the document sheet 90 set on a document sheet placement portion 121 through the reading position on the document sheet table 111 to a sheet discharge tray 123.

In the example shown in FIG. 1, the ADF 12 includes a document sheet sensor 802 configured to sense whether or not the document sheet 90 is placed on the document sheet placement portion 121. For example, the document sheet sensor 802 is conceivably a microswitch whose state changes depending on the presence or absence of load of the document sheet 90.

In the image forming apparatus 10, each of the sheet feeding portions 2 feeds the sheet material 9 for printing to the image forming portion 4. The sheet feeding portions 2 each include a sheet receptacle 21 and a sheet sending-out portion 22.

The sheet receptacle 21 is configured such that multiple sheets of the sheet material 9 can be stacked and placed thereon. The sheet sending-out portion 22 is configured to send a single sheet of the sheet material 9 at a time, placed on the sheet receptacle 21 to a conveying path 30 that leads to the image forming portion 4. The sheet material 9 is fed from one of the sheet feeding portions 2 to the image forming portion 4 via the sheet conveying portion 3.

The plurality of the sheet feeding portions 2 include cassette-type first sheet feeding portions 2a, and a manual sheet-feed type second sheet feeding portion 2b. The first sheet feeding portions 2a are referred to as, for example, sheet-feed cassettes, paper cassettes, and the like.

Each of the first sheet feeding portions 2a includes a cassette-type sheet receptacle 21 installed in a removable manner with respect to a housing 100 (main body) of the image forming apparatus 10. The second sheet feeding portion 2b includes a manual sheet-feed type sheet receptacle 21 that can be folded with respect to the housing 100 (main body) of the image forming apparatus 10.

The sheet conveying portion 3 includes registration rollers 31, conveying rollers 32, and discharge rollers 33, etc. The registration rollers 31 and the conveying rollers 32 convey the sheet material 9 fed from one of the sheet feeding portions 2 to the image forming portion 4 along the conveying path 30. Then, the discharge rollers 33 discharge the sheet material 9 after image formation from a discharge port of the conveying path 30 onto a discharge tray 101.

The image forming portion 4 executes the printing process of forming an image on the sheet material 9 fed from the sheet receptacle 21 of one of the sheet feeding portions 2. The image forming portion 4 includes a drum-like photoconductor 41, a charging portion 42, a developing portion 43, a transfer portion 45, and a cleaning portion 47, etc. It should be noted that the photoconductor 41 is one example of an image carrier.

The charging portion 42 uniformly charges the surface of the photoconductor 41 when the photoconductor 41 rotates. Then, the light scanning portion 5 conducts scanning with laser light to write an electrostatic latent image on the charged surface of the photoconductor 41, and the developing portion 43 supplies a toner 900 on the photoconductor 41 to develop the electrostatic latent image into a toner image.

In addition, the transfer portion 45 transfers the toner image on the photoconductor 41 onto the sheet material 9 that is moving along the conveying path 30. Then, the cleaning portion 47 removes the toner 900 remaining on the surface of the photoconductor 41.

The fixing portion 6 nips, between a pressure roller 62 and a fixing roller 61 including a heater 610, the sheet material 9 on which the toner image is formed, and sends the sheet material 9 to later steps. At that moment, the heater 610 heats, through the fixing roller 61, the toner image formed on the sheet material 9. With this, the fixing portion 6 fixes, onto the sheet material 9, the toner image (image) formed on the sheet material 9. It should be noted that the toner 900 is one example of a developer.

The operation display portion 80 includes: an operation portion for inputting information including, for example, a touch panel, an operation button, and the like; and a display portion including a liquid crystal display panel, a notification lamp, and the like. For example, the operation portion includes a menu display key, a cursor control key, a start key, and the like.

The menu display key is an operation key for displaying various types of setting screens on the display portion. The cursor control key is an operation key for moving a cursor in the setting screens displayed on the display portion.

The start key is an operation key for generating start events of various types of processes such as a document sheet scanning process of reading an image on the document sheet 90, and the copy job including the document sheet scanning process. In addition, the touch panel functions as various types of operation keys such as, for example, text input keys.

In the present embodiment, the operation display portion 80 includes an authentication information input portion 800. The authentication information input portion 800 is a component for inputting user authentication information D00 to identify a user in response to an operation performed by the user with respect to the image forming apparatus 10. It should be noted that the authentication information input portion 800 is one example of an input portion for inputting information that identifies a user.

Conceivable examples that may be used as the authentication information input portion 800 include a fingerprint sensor for inputting fingerprint information as the user authentication information D00, an RFID reader (Radio Frequency IDentifier Reader) for reading the user authentication information D00 from a nearby RF tag (Radio Frequency Tag) through near field communication, an IC card reader for reading the user authentication information D00 from an IC card, and the like.

The control portion 8 displays the setting screens and an operation menu on the operation display portion 80. Furthermore, the control portion 8 controls electrical devices such as peripheral devices and motors in accordance with sensing results from various types of sensors and input information inputted through an operation performed on the operation display portion 80.

[Control Portion 8]

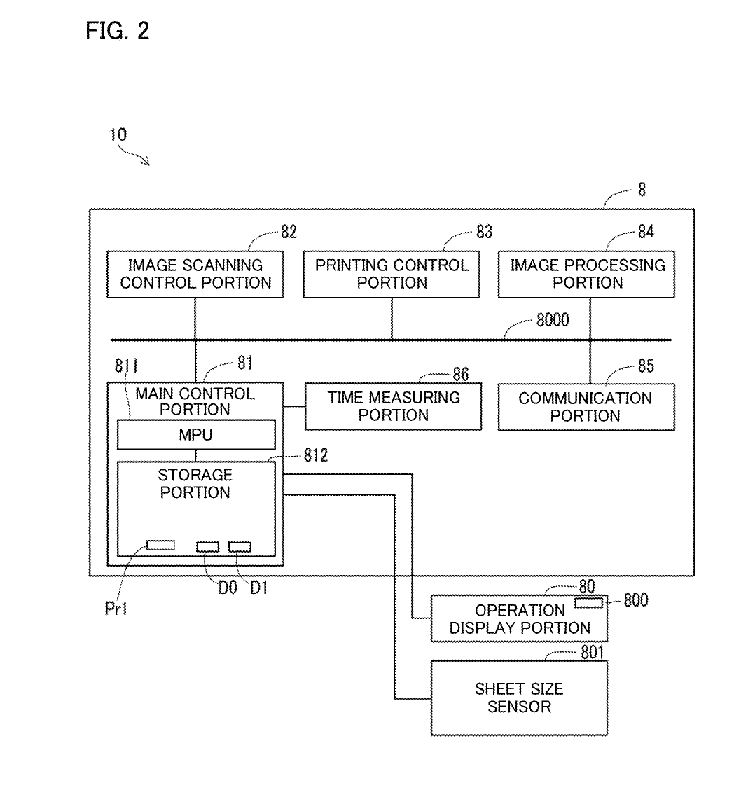

As shown in FIG. 2, the control portion 8 includes a main control portion 81, an image scanning control portion 82, a printing control portion 83, an image processing portion 84, and a communication portion 85, etc. The main control portion 81 includes an MPU (Micro Processor Unit) 811 and a non-transitory computer-readable storage portion 812.

The main control portion 81, the image scanning control portion 82, the printing control portion 83, the image processing portion 84, and the communication portion 85 are each connected to a bus 8000, and can transfer data among each other through the bus 8000.

The MPU 811 is a processor for executing various types of calculations and data processing. The storage portion 812 is a nonvolatile storage portion for storing various types of information referred to by the MPU 811. In addition, the storage portion 812 is also a storage portion from/into which the MPU 811 can read/write various types of information.

For example, the storage portion 812 stores programs for causing the MPU 811 to execute various types of processes, and information referred to by the MPU 811 that executes such programs. In addition, the storage portion 812 in the present embodiment stores registered user information D0.

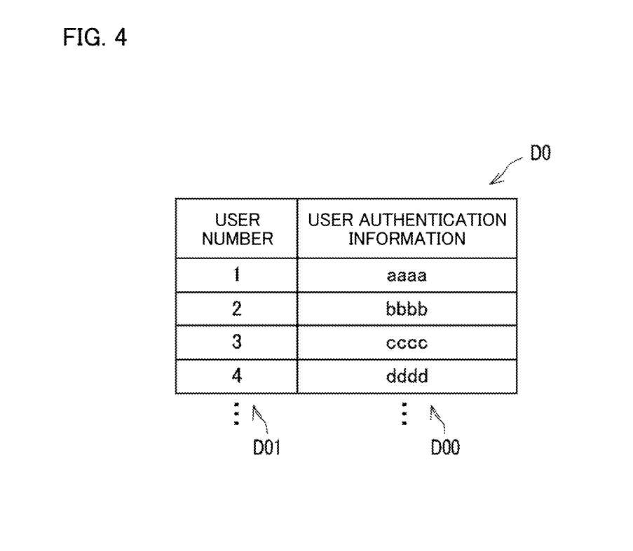

The registered user information D0 includes information for identifying each user who can use the image forming apparatus 10. FIG. 4 shows one example of the data organization of the registered user information D0.

In the example shown in FIG. 4, the registered user information D0 includes user numbers D01 and the respective user authentication information D00 in association with each other. The user authentication information D00 is information inputted through the authentication information input portion 800 in advance for each user who can use the image forming apparatus 10. The user numbers D01 are numbers for identifying the respective user authentication information D00 included in the registered user information D0.

By having the MPU 811 execute various types of programs stored in the storage portion 812 in advance, the main control portion 81 collectively controls the image forming apparatus 10. The main control portion 81 also includes a not-shown volatile storage portion such as a RAM for temporarily storing programs for causing the MPU 811 to execute respective steps described later.

In the document sheet scanning process, the image scanning control portion 82 executes a process of scanning the document sheet 90 by controlling the document sheet conveying/reading portion 1 and acquires document sheet image data from the image reading portion 11. The document sheet image data is image data read from the document sheet 90. Furthermore, the image scanning control portion 82 transfers the document sheet image data to other instruments such as the image processing portion 84 through the bus 8000.

The printing control portion 83 acquires the image data that is to be printed from the image processing portion 84, and causes the image forming portion 4 and the light scanning portion 5 to execute a printing process of forming, on the sheet material 9, an image based on the image data to be printed. The printing process is executed as one part of the copy job for the to-be-printed image data converted from the document sheet image data obtained from the document sheet scanning process. In addition, the printing process is also executed for the to-be-printed image data converted from data of the print job.

The image processing portion 84 executes various types of data processing with respect to image data and the like obtained from other instruments through the bus 8000. The subject of data processing by the image processing portion 84 is, for example, the document sheet image data obtained from the image reading portion 11 through the image scanning control portion 82, the print job obtained from a terminal device 7 through the communication portion 85, or the like.

For example, the image processing portion 84 converts the document sheet image data obtained from the image scanning control portion 82 and the print job obtained from the communication portion 85 into the image data to be printed, and executes a process of transferring those to the printing control portion 83. Furthermore, the image processing portion 84 also has the functions of conducting image processing such as image rotation, half-toning, size cutting, and the like with respect to the document sheet image data obtained from the image scanning control portion 82.

The communication portion 85 is a communication interface configured to transmit/receive data to/from information processing apparatuses such as a personal computer or the like via a communication line such as a LAN (Local Area Network). Furthermore, the communication portion 85 transfers data to/from other instruments of the image forming apparatus 10 through the bus 8000.

For example, the main control portion 81 executes a user authentication process, and, only when the user authentication is successful, allows usage of the image forming apparatus 10 such as execution of the copy job until a predetermined authentication termination condition is satisfied.

The user authentication process is a process of determining, when the user authentication information D00 is inputted via the authentication information input portion 800, the outcome of the user authentication depending on whether or not the inputted user authentication information D00 is included in the registered user information D0.

In addition, when the main control portion 81 detects a copy start operation performed with respect to the operation display portion 80, the main control portion 81 causes the image scanning control portion 82 and the printing control portion 83 to execute the copy job. At that moment, the main control portion 81 causes the image scanning control portion 82 to execute the document sheet scanning process, and causes the printing control portion 83 to execute the printing process.

A time measuring portion 86 is a clock circuit that measures the date and time. Measured time information of the time measuring portion 86 is transmitted to the main control portion 81.

In a conventional image forming apparatus, when the printing process in which the manual sheet-feed type second sheet feeding portion 2b is set as the feeding source of the sheet material 9 is to be conducted; a user has to perform, with respect to an operation portion of the image forming apparatus, an operation of selecting an image formation condition depending on the type of the sheet material 9.

However, the operation of selecting the image formation condition every time a different type of the sheet material 9 is placed on the sheet receptacle 21 of the second sheet feeding portion 2b is troublesome for the user.

On the other hand, with the image forming apparatus 10, it is possible to omit the time and effort of selecting the image formation condition depending on the type of the sheet material 9, every time various types of the sheet material 9 are placed on the sheet receptacle 21 of the second sheet feeding portion 2b. Details of that will be described in the following.

[Registered Condition Information D1]

In the image forming apparatus 10, the storage portion 812 stores registered condition information D1 in advance, before the copy job in which the second sheet feeding portion 2b is set as the feeding source of the sheet material 9 is executed. The registered condition information D1 is information representing the correspondence relationship between the size of the sheet material 9 and the printing condition. It should be noted that a part in the storage portion 812 for storing the registered condition information D1 is one example of a first storage portion configured to store the registered condition information D1 in advance.

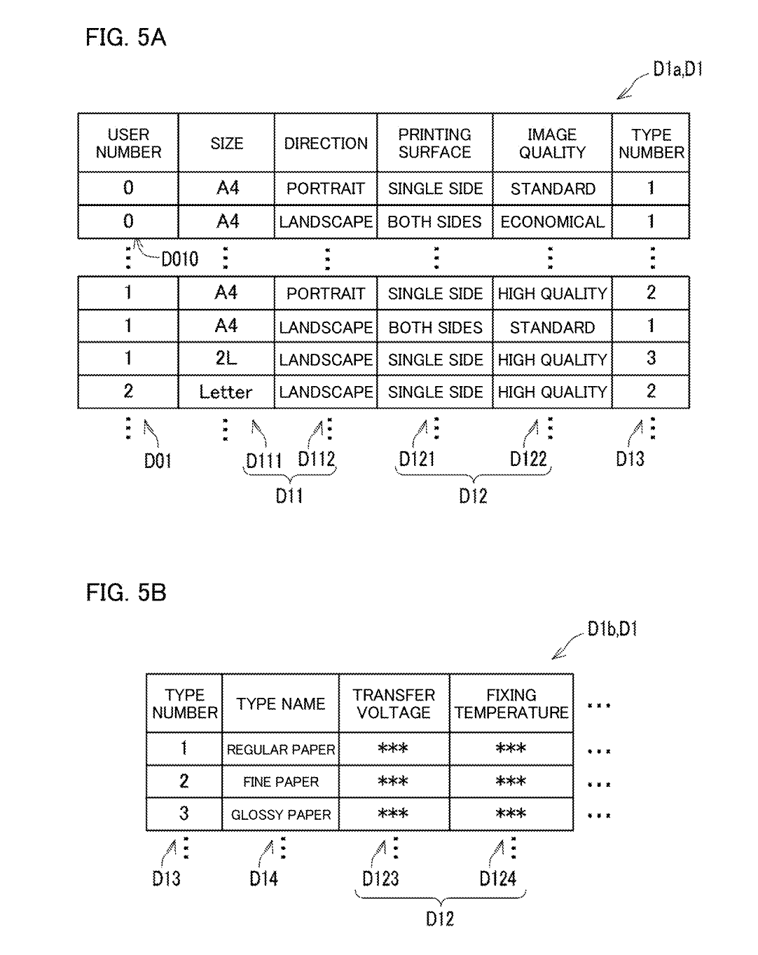

FIG. 5 shows one example of data organization of the registered condition information D1. In the example shown in FIG. 5, the registered condition information D1 includes first registered condition information D1a and second registered condition information D1b. FIG. 5A shows data organization of the first registered condition information D1a, and FIG. 5B shows data organization of the second registered condition information D1b.

The first registered condition information D1a includes the user numbers D01, and a part of printing-condition information D12 and feeding sheet-size information D11 corresponding to the user numbers D01. Furthermore, the first registered condition information D1a includes sheet type numbers D13 corresponding to the user numbers D01.

The second registered condition information D1b includes the sheet type numbers D13, and the other part of the printing-condition information D12 and sheet type names D14 corresponding to the sheet type numbers D13.

The feeding sheet-size information D11 includes sheet-size information D111 representing the size of the sheet material 9 without specifying the direction, and sheet direction information D112 representing the direction of the sheet material 9 placed on the sheet receptacle 21.

Thus, the feeding sheet-size information D11 can be regarded as information representing the size of the sheet material 9 or information representing the size of the sheet material 9 with the direction thereof specified, when being fed from the sheet receptacle 21.

The printing-condition information D12 is information representing the printing condition when the copy job is executed. For example, the printing-condition information D12 conceivably includes printing surface designating information D121, image quality designating information D122, transfer voltage setting information D123, and fixing temperature setting information D124, etc.

The printing surface designating information D121 is information designating whether to conduct single-sided printing of forming the image on only one surface of the sheet material 9 or double-sided printing of forming the image on both sides of the sheet material 9.

The image quality designating information D122 is information designating the image quality of a print image, and is selected from, for example, selection choices such as standard, high quality, and “economical”. It should be noted that the “economical” among the selection choices is information designating formation of an image obtained by reducing usage amount of the toner 900 through culling of rendered pixels.

The sheet type numbers D13 are numbers for identifying the type of the sheet material 9 such as regular paper, fine paper, or glossy paper, and are also information specifying the printing-condition information D12 representing the printing condition suitable for the type of the sheet material 9.

In the example shown in FIG. 5, the printing-condition information D12 corresponding to the type of the sheet material 9 includes the fixing temperature setting information D124 and the transfer voltage setting information D123, which are examples of information designating control parameters used in the printing process.

The transfer voltage setting information D123 is information designating the voltage applied on the transfer portion 45, and the fixing temperature setting information D124 is information designating a target value for the heating temperature of the heater 610 in the fixing portion 6.

When the first registered condition information D1a is set in accordance with a user operation on the image forming apparatus 10 or on an information processing apparatus that is communicable with the image forming apparatus 10; the sheet type names D14 is information that is presented to the user as a selection choice for the type of the sheet material 9.

As shown above, the registered condition information D1 is information representing the correspondence relationship between the printing condition and the size of the sheet material 9 for each of the user numbers D01. It should be noted that each of the user numbers D01 and the user authentication information D00 are examples of user identification information.

In addition, the user number D01 being “0” in the registered condition information D1 means not being related to any specific user. Thus, the printing-condition information D12 corresponding to the user number D01 of “0” shows printing condition that is common to all users or an initial state of the printing condition.

[Sheet Size Sensor 801]

In addition, the image forming apparatus 10 includes a sheet size sensor 801 for sensing the size of the sheet material 9 placed on the sheet receptacle 21 of the second sheet feeding portion 2b. It should be noted that the sheet size sensor 801 is one example of a sheet size sensing portion.

For example, the sheet size sensor 801 conceivably includes a sheet width sensing portion 801a and a sheet length sensing portion 801b. In the following description, the dimension of the sheet material 9 in a direction orthogonal to the delivering direction of the sheet material 9 from the sheet receptacle 21 is referred to as a sheet width, and the dimension of the sheet material 9 in the delivering direction of the sheet material 9 is referred to as a sheet length.

The sheet width sensing portion 801a is configured to sense the sheet width of the sheet material 9 placed on the sheet receptacle 21. For example, the sheet width sensing portion 801a conceivably includes one pair of sheet guiding portions and a variable resistance portion.

The pair of sheet guiding portions is configured such that the interval therebetween in the direction orthogonal to the delivering direction of the sheet material 9 can be changed, and is a part that indicates positions of the two lateral sides of the sheet material 9. The variable resistance portion is an electrical component whose electrical resistance changes depending on the interval between the pair of sheet guiding portions. In this case, the voltage in a partial resistance circuit including the variable resistance portion represents the sheet width.

In addition, the sheet length sensing portion 801b senses the sheet length of the sheet material 9 placed on the sheet receptacle 21 of the second sheet feeding portion 2b. For example, the sheet length sensing portion 801b conceivably includes multiple microswitches whose states each change depending on the presence or absence of load of the sheet material 9. The multiple microswitches are arranged side by side in the delivering direction of the sheet material 9 on the sheet receptacle 21. In this case, the number of the microswitches in the ON-state represents the sheet length.

In addition, the sheet length sensing portion 801b doubles as a sheet detection sensor configured to sense whether or not the sheet material 9 is placed on the sheet receptacle 21 of the second sheet feeding portion 2b.

The sheet size sensor 801 conceivably is an optical-type non-contact sensor, or includes a camera and an image processing portion for conducting image processing on image data obtained from the camera.

[Manual Sheet-Feed Printing Control]

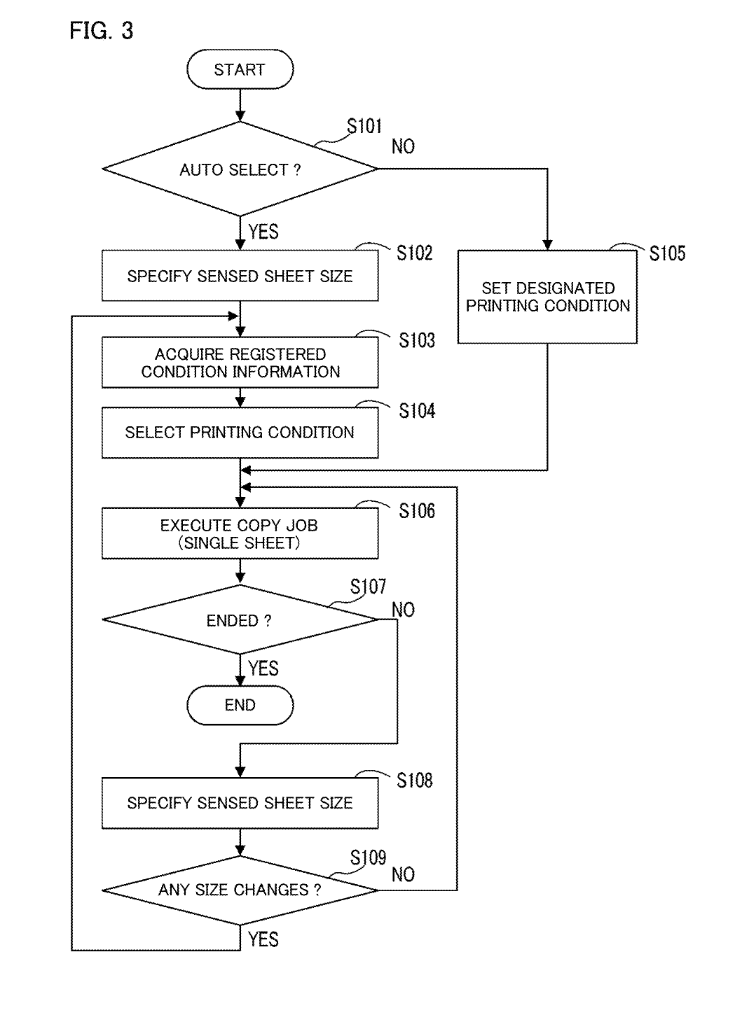

Next, with reference to a flowchart shown in FIG. 3, one example of procedural steps of a manual sheet-feed printing control executed by the main control portion 81 will be described. By having the MPU 811 execute a manual sheet-feed printing control program Pr1, the manual sheet-feed printing control is achieved by the main control portion 81. In the following description, S101, S102, . . . , each represent an identification sign of a step executed by the main control portion 81.

The main control portion 81 executes the manual sheet-feed printing control when the copy start operation performed with respect to the operation display portion 80 is detected in a state where the sheet material 9 on the sheet receptacle 21 is sensed by the sheet size sensor 801. In addition, before the copy start operation is conducted, whether or not to designate an auto select mode for the printing condition is selected through the operation display portion 80.

The auto select mode is an operation mode in which the image forming apparatus 10 automatically selects the printing condition when executing the copy job in accordance with the sensing results from the sheet size sensor 801. In the following description, the size of the sheet material 9 specified from the sensing results of the sheet size sensor 801 is referred to as a sensed sheet size.

<Step S101>

In the manual sheet-feed printing control, the main control portion 81 determines whether or not the auto select mode of the printing condition is designated, and selects the step to be executed next in accordance with the determination result.

<Step S102>

When the auto select mode is designated, the main control portion 81 specifies the sensed sheet size from the sensing results of the sheet size sensor 801.

<Step S103>

Furthermore, the main control portion 81 acquires the registered condition information D1 from the storage portion 812. At that moment, the main control portion 81 reads out, from the storage portion 812, the registered condition information D1 corresponding to the user authentication information D00 inputted via the authentication information input portion 800 in the user authentication process, which has been successful, before step S101.

It should be noted that the main control portion 81 that executes the process at step S103 is one example of a registered condition information acquisition portion configured to acquire the registered condition information D1 from the storage portion 812 that stores, in advance, the registered condition information D1 representing the correspondence relationship between the printing condition and the size of the sheet material 9.

<Step S104>

Next, the main control portion 81 selects the printing condition corresponding to the sensed sheet size in the registered condition information D1. More specifically, the main control portion 81 selects, as information of the printing condition used when executing the copy job which is to be executed hereafter, the printing-condition information D12 corresponding to the feeding sheet-size information D11 representing the sensed sheet size in the registered condition information D1 acquired at step S103.

It should be noted that the registered condition information D1 corresponding to the user authentication information D00 used in the successful user authentication process conceivably does not include the feeding sheet-size information D11 representing the sensed sheet size. In this case, the main control portion 81 selects the initial state of the predetermined printing condition. In the present embodiment, the printing-condition information D12 corresponding to the user number D01 of “0” in the registered condition information D1 represents the initial state of the printing condition.

<Step S105>

On the other hand, when the auto select mode of the printing condition is not designated, the main control portion 81 sets, as the printing condition used when executing the copy job, the printing condition designated by the user in advance. The printing condition designated by the user is set in accordance with an operation performed with respect to the operation display portion 80 before the copy start operation is performed with respect to the operation display portion 80. Furthermore, when the designating of the printing condition by the user is not performed, the initially set printing condition is used.

<Step S106>

Furthermore, the main control portion 81 causes the image scanning control portion 82 and the printing control portion 83 to execute the copy job including the document sheet scanning process and the printing process. At that moment, the printing control portion 83 causes the image forming portion 4 to execute the printing process on a single sheet of the sheet material 9 in accordance with the printing condition selected at step S104 or the printing condition that has been set at step S105.

When the process at step S106 is executed after step S104, the printing control portion 83 causes the image forming portion 4 to execute the printing process in accordance with the printing condition corresponding to the sensed sheet size in the registered condition information D1 (S106).

<Step S107>

Then, the main control portion 81 determines whether or not a predetermined copy termination condition has been satisfied, and ends the copy job when the copy termination condition is satisfied.

For example, the copy termination condition includes a predetermined termination operation being performed with respect to the operation display portion 80. In addition, the copy termination condition conceivably also includes the document sheet sensor 802 changing states from sensing the document sheet 90 to not sensing the document sheet 90 in a situation where a continuous reading mode is not designated. The continuous reading mode is an operation mode of continuously executing a series of the copy job without initializing the printing condition until the termination operation is performed.

<Step S108>

When the copy termination condition is not satisfied, the main control portion 81 specifies the sensed sheet size of the next sheet material 9 from the sensing results of the sheet size sensor 801. At that moment, the previous sensed sheet size is temporarily stored.

<Step S109>

Furthermore, the main control portion 81 determines whether or not the sensed sheet size obtained at step S108 has changed from the previous sensed sheet size.

When the sensed sheet size has not been changed, the main control portion 81 repeats the processes from step S106 for the next single sheet of the sheet material 9. As a result, the printing control portion 83 causes the image forming portion 4 to execute the printing process on the next single sheet of the sheet material 9 in accordance with the printing condition identical to the previous one.

On the other hand, when the sensed sheet size has been changed from the previous size, the main control portion 81 repeats the processes from step S103. As a result, the main control portion 81 begins from reselecting the printing condition corresponding to the new sensed sheet size.

In the present embodiment, since the registered condition information D1 is set in advance, by simply placing the sheet material 9 on the sheet receptacle 21 of the second sheet feeding portion 2b, the printing condition in accordance with the size of that sheet material 9 is automatically selected.

Thus, with the present embodiment, it is possible to omit the time and effort of selecting the printing condition depending on the type of the sheet material 9, every time the sheet material 9 is placed on the sheet receptacle 21 of the second sheet feeding portion 2b. As a result, the convenience increases for the case where the printing process is conducted by using the manual sheet-feed type second sheet feeding portion 2b on which various types of the sheet material 9 are placed.

In addition, in the present embodiment, the storage portion 812 stores the registered condition information D1 representing the correspondence relationship between the printing condition and the size of the sheet material 9 for each of the user authentication information D00, which is one example of user identification information. Furthermore, the main control portion 81 acquires, from the storage portion 812, the registered condition information D1 corresponding to the user authentication information D00 obtained through the authentication information input portion 800 (S103).

Thus, the printing condition suited for each user is automatically selected. As a result, the convenience for the individual user increases.

In addition, the main control portion 81 determines the presence or absence of any changes in the size sensed by the sheet size sensor 801, every time the sheet material 9 is fed from the sheet receptacle 21 of the second sheet feeding portion 2b to the image forming portion 4 (S108, S109). The main control portion 81 that executes the processes at steps S108 and S109 is one example of a size change determination portion.

Furthermore, every time the sensed sheet size changes, the printing control portion 83 causes the image forming portion 4 to execute the printing process in accordance with the printing condition corresponding to the sensed sheet size that has been changed (S103, S104, S106).

Thus, when the printing process is to be executed on multiple sheets of the sheet material 9, during that time, even if a different type of the sheet material 9 is placed on the sheet receptacle 21 of the second sheet feeding portion 2b, the user does not have to perform an operation of selecting the printing condition for each type of the sheet material 9.

### Second Embodiment

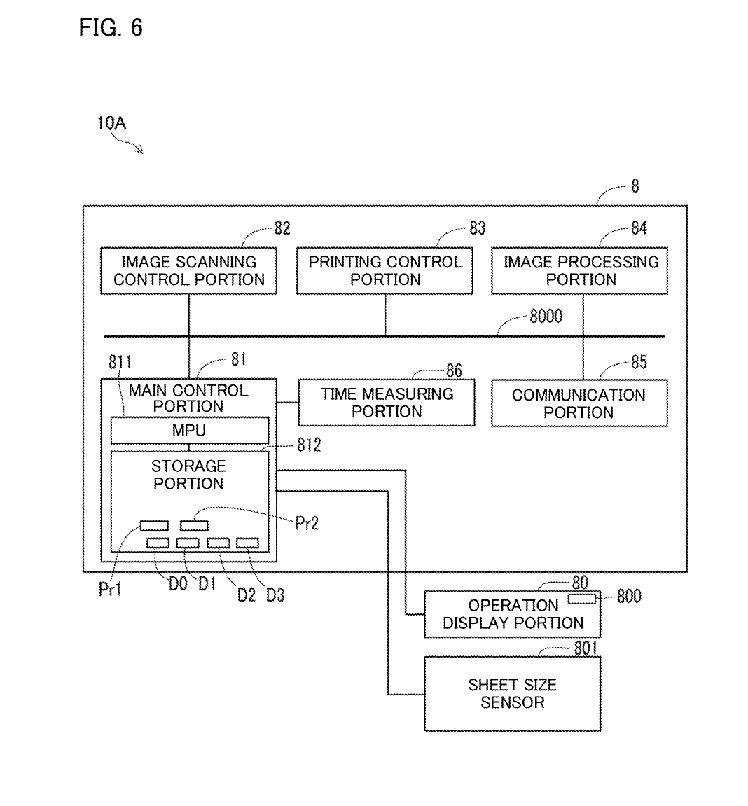

Next, an image forming apparatus 10A according to a second embodiment will be described with reference to FIGS. 6 to 9. When compared to the image forming apparatus 10, the image forming apparatus 10A includes partially extended functions.

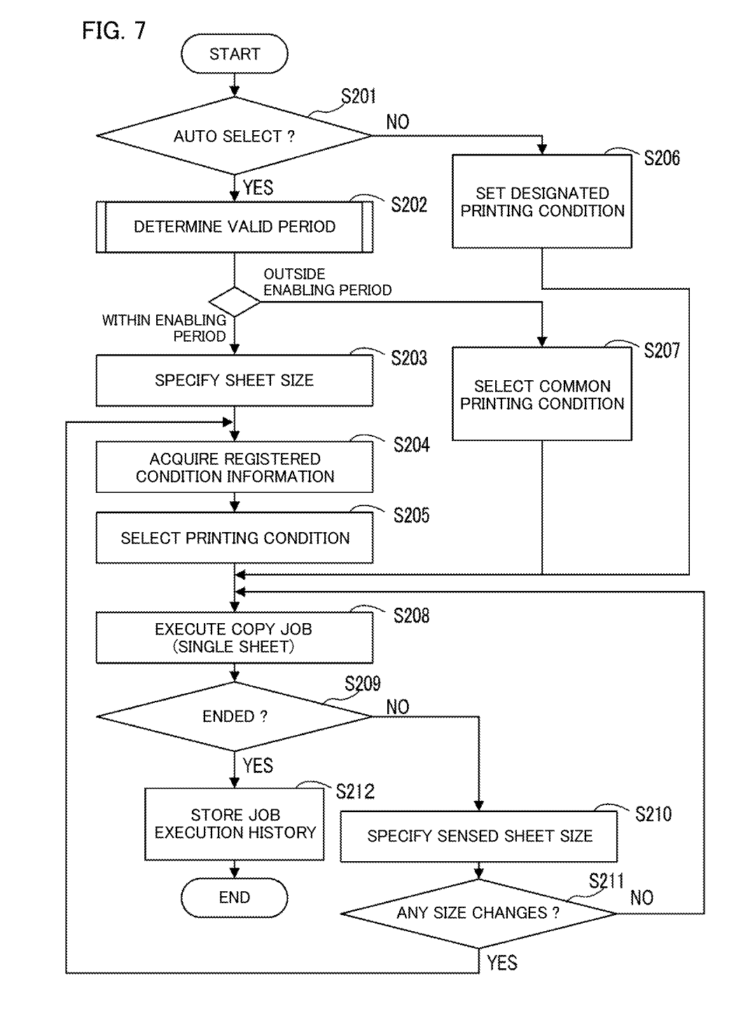

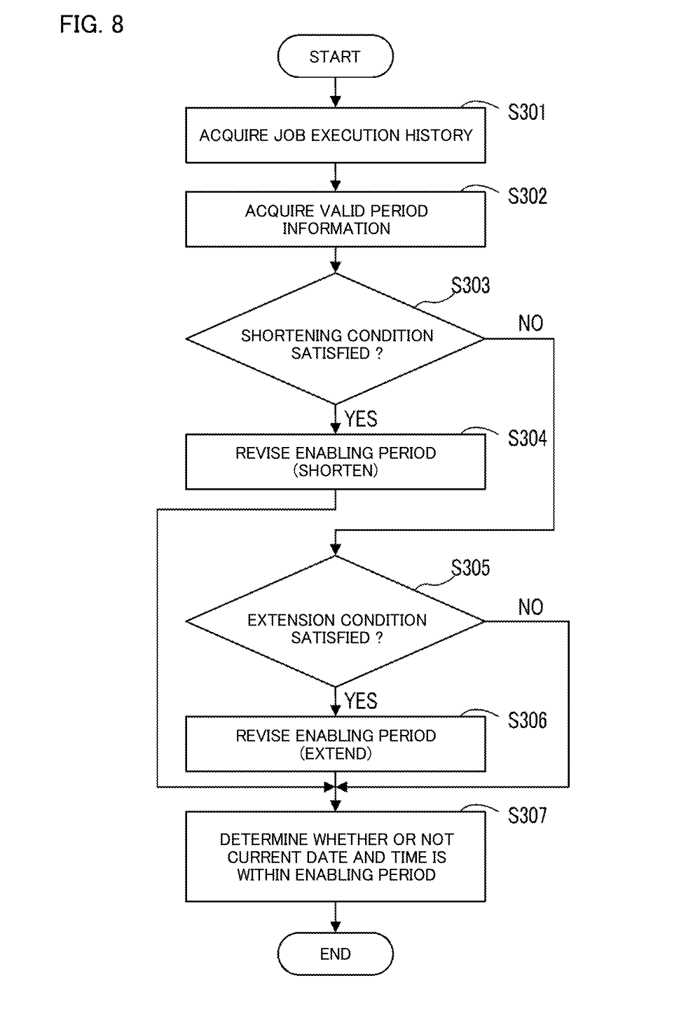

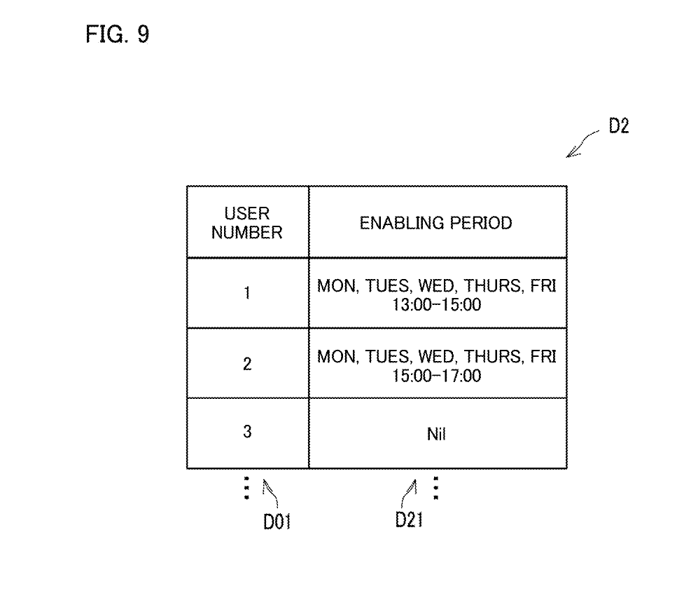

FIG. 6 is a block diagram of control-related portions included in the image forming apparatus 10A. FIG. 7 is a flowchart representing one example of the procedures of the manual sheet-feed printing control in the image forming apparatus 10A. FIG. 8 is a flowchart representing one example of the procedures of a valid period determination process in the image forming apparatus 10A. FIG. 9 is a data organization view of valid period information D2 referred to by the image forming apparatus 10A.

In FIGS. 6 to 9, the same components as those in FIGS. 1 to 5 are designated by the same reference characters. In the following, the difference of the image forming apparatus 10A from the image forming apparatus 10 will be described.

[Valid Period Information D2]

In the image forming apparatus 10A, the storage portion 812 stores, in advance, the valid period information D2 in addition to the registered condition information D1, before the copy job in which the second sheet feeding portion 2b is set as the feeding source of the sheet material 9 is executed. The valid period information D2 is information representing a period during which the printing process based on the registered condition information D1 is enabled. A part in the storage portion 812 for storing enabling period information D2 is one example of a second storage portion configured to store the valid period information D2 in advance.

In the example shown in FIG. 9, the valid period information D2 includes the enabling period information D21 representing the period during which the printing process based on the registered condition information D1 is enabled. For example, the enabling period information D21 is conceivably a day of the week, a time slot, or a combination thereof. In addition, the enabling period information D21 conceivably includes information representing day, month, and year.

Furthermore, the valid period information D2 conceivably includes disabling period information instead of, or in addition to the enabling period information D21. In this case, a period other than the period represented in the disabling period information is the period during which the printing process based on the registered condition information D1 is enabled.

In addition, in the present embodiment, the valid period information D2 includes the user numbers D01 representing the subject for which the printing process based on the registered condition information D1 is enabled or disabled. More specifically, the valid period information D2 includes the enabling period information D21 for each of the user numbers D01.

Furthermore, in the valid period information D2, “Nil” can be set as the enabling period information D21 corresponding to the user number D01. Having “Nil” set as the enabling period information D21 means, for the user corresponding to the user number D01, the printing process based on the registered condition information D1 is constantly disabled; and more specifically means constantly being outside the enabling period.

The valid period information D2, in which “Nil” can be set as the enabling period information D21 for each of the user numbers D01, is also one example of valid user information including the user identification information and representing a user for which the printing process based on the registered condition information D1 is enabled or disabled. In addition, a part in the storage portion 812 for storing the enabling period information D21 is also one example of a third storage portion configured to store the valid user information in advance.

Furthermore, in the image forming apparatus 10A, the storage portion 812 also stores a valid period determination program Pr2 for causing the MPU 811 to execute the valid period determination process described later.

[Manual Sheet-Feed Printing Control]

Next, with reference to a flowchart shown in FIG. 7, one example of procedural steps of the manual sheet-feed printing control executed by the main control portion 81 in the image forming apparatus 10A will be described. By having the MPU 811 execute the manual sheet-feed printing control program Pr1, the manual sheet-feed printing control is achieved by the main control portion 81. In the following description, S201, S202, . . . , each represent an identification sign of a step executed by the main control portion 81 of the image forming apparatus 10A.

Also in the image forming apparatus 10A, the main control portion 81 executes the manual sheet-feed printing control under a condition similar to the case with the image forming apparatus 10.

<Step S201>

Similarly to step S101 in FIG. 3, the main control portion 81 of the image forming apparatus 10A determines whether or not the auto select mode of the printing condition is designated, and selects the step to be executed next in accordance with the determination result.

<Step S202>

When the auto select mode is designated, the main control portion 81 executes the valid period determination process. The valid period determination process is a process of determining whether or not the present time point is within the period during which the printing process based on the registered condition information D1 is enabled. Details of the valid period determination process will be described later. It should be noted that the time measuring portion 86 measures the preset date and time.

<Steps S203 to S205>

When the present time point is within the period during which the printing process based on the registered condition information D1 is enabled, similarly to steps S102 to S104 in FIG. 3, the main control portion 81 executes the respective processes of specifying the sensed sheet size (S203), acquiring the registered condition information D1 (S204), and automatically selecting the printing condition (S205).

<Step S206>

On the other hand, when the auto select mode of the printing condition is not designated, similarly to step S105 in FIG. 3, the main control portion 81 sets, as the printing condition used when executing the copy job, the printing condition designated by the user in advance.

<Step S207>

When the present time point is not within the period during which the printing process based on the registered condition information D1 is enabled, the main control portion 81 selects the printing condition that is common for all users as the printing condition used when executing the copy job. The printing condition common for all users is a condition represented by the printing-condition information D12 corresponding to the user number D01 of “0” in the registered condition information D1.

<Step S208>

Furthermore, the main control portion 81 causes the image scanning control portion 82 and the printing control portion 83 to execute the copy job including the document sheet scanning process and the printing process. At that moment, the printing control portion 83 causes the image forming portion 4 to execute the printing process on a single sheet of the sheet material 9 in accordance with the printing condition selected at step S205, the printing condition that has been set at step S206, or the printing condition selected at step S207.

<Step S209>

Then, similarly to step S107 in FIG. 3, the main control portion 81 determines whether or not the copy termination condition is satisfied.

<Steps S210, S211>

When the copy termination condition is not satisfied, similarly to steps S108 and S109 in FIG. 3, the main control portion 81 executes the process of specifying the sensed sheet size from the sensing results of the sheet size sensor 801 (S210), and the process of determining whether or not the sensed sheet size has been changed from the previous size (S211).

When the sensed sheet size has not been changed, the main control portion 81 repeats the processes from step S208 for the next single sheet of the sheet material 9. As a result, the printing control portion 83 causes the image forming portion 4 to execute the printing process on the next single sheet of the sheet material 9 in accordance with the printing condition identical to the previous one.

On the other hand, when the sensed sheet size has been changed from the previous size, the main control portion 81 repeats the processes from step S204. As a result, the main control portion 81 begins from reselecting the printing condition corresponding to the new sensed sheet size.

<Step S212>

On the other hand, when the copy termination condition is satisfied, the main control portion 81 causes the storage portion 812 to store job execution history information D3. The job execution history information D3 is information representing the execution history of various types of jobs such as the copy job by the image forming apparatus 10A. For example, the job execution history information D3 conceivably includes previous-job end-date-and-time information representing the date and time of the lastly executed job for each type of the job, and previous sheet feed source information that identifies the sheet feeding portion 2 used in the last job.

In the present embodiment, the job execution history information D3 includes the user numbers D01 and the previous-job end-date-and-time information for each type of job in association with each other. The user numbers D01 included in the job execution history information D3 are the user numbers D01 corresponding to the user authentication information D00 inputted via the authentication information input portion 800 in the user authentication process, which has been successful, conducted before step S201.

The job execution history information D3 is one example of information representing a feeding status of the sheet material 9 from the sheet receptacle 21. In addition, the job execution history information D3 in the present embodiment is information representing the feeding status of the sheet material 9 from the sheet receptacle 21 for each user. The main control portion 81 ends the copy job after the process at step S212 ends.

[Valid Period Determination Process]

Next, one example of the valid period determination process will be described with reference to the flowchart shown in FIG. 8. By having the MPU 811 execute the valid period determination program Pr2, the valid period determination process is achieved by the main control portion 81. In the following description, S301, S302, . . . , each represent an identification sign of a step executed by the main control portion 81.

<Steps S301, S302>

In the valid period determination process, first, the main control portion 81 acquires, from the storage portion 812, the job execution history information D3 (S301), and further acquires the valid period information D2 (S302). At that moment, the main control portion 81 acquires, from the storage portion 812, the valid period information D2 and the job execution history information D3 corresponding to the user authentication information D00 inputted via the authentication information input portion 800 in the user authentication process, which has been successful, conducted before step S201.

<Step S303>

Next, the main control portion 81 determines whether or not a predetermined shortening condition is satisfied. The shortening condition is a condition for determining whether or not to shorten the period represented by the enabling period information D21, and is a condition that relates to the feeding status of the sheet material 9 from the sheet receptacle 21.

For example, the shortening condition is conceivably a condition of “a job, in which the second sheet feeding portion 2b is set as the feeding source of the sheet material 9, not being executed within a predetermined shortening determination period after the start of the enabling period represented by the enabling period information D21 acquired at step S302”.

For the determination of the shortening condition, the usage status of the second sheet feeding portion 2b is specified based on the previous-job end-date-and-time information and the previous sheet feed source information in the job execution history information D3 acquired at step S301.

<Step S304>

When the shortening condition is satisfied, the main control portion 81 revises and shortens the enabling period represented by the enabling period information D21 acquired at step S302. For example, the main control portion 81 conceivably revises the end time of the enabling period represented by the enabling period information D21 acquired at step S302, to a time point when the shortening determination period has elapsed after the start time of the enabling period. In this case, the current date and time will not be determined as being within the revised enabling period. It should be noted that the current date and time is measured by the time measuring portion 86.

<Step S305>

On the other hand, when the shortening condition is not satisfied, the main control portion 81 determines whether or not a predetermined extension condition is satisfied. The extension condition is a condition for determining whether or not to extend the period represented by the enabling period information D21, and is a condition that relates to the feeding status of the sheet material 9 from the sheet receptacle 21.

For example, the extension condition is conceivably a condition of “a job, in which the second sheet feeding portion 2b is set as the feeding source of the sheet material 9, not being executed within a period, measured backward in time for the length of a predetermined extension determination period, from an end time in the enabling period represented by the enabling period information D21 acquired at step S302”.

For the determination with the extension condition, the usage status of the second sheet feeding portion 2b is specified based on the previous-job end-date-and-time information and the previous sheet feed source information in the job execution history information D3 acquired at step S301.

<Step S306>

When the extension condition is satisfied, the main control portion 81 revises and extends the enabling period represented by the enabling period information D21 acquired at step S302. For example, the main control portion 81 conceivably revises, backward in time by a length of a predetermined period, the end time of the enabling period represented by the enabling period information D21 acquired at step S302.

<Step S307>

Then, the main control portion 81 determines whether or not the current date and time is within the enabling period. When the enabling period is shortened or extended as a result of the shortening condition or the extension condition being satisfied; the enabling period that is to be compared with the current date and time in the present step is the enabling period obtained by revising the period represented by the enabling period information D21. On the other hand, when the shortening condition and the extension condition are not satisfied, the enabling period to be compared with the current date and time at the present step is the period represented by the enabling period information D21.

The main control portion 81 that executes the process at step S302 is one example of a valid period information acquisition portion configured to acquire the valid period information D2 from the storage portion 812 storing the valid period information D2 in advance.

In addition, the main control portion 81 that executes the process at step S202, i.e., the processes at steps S301 to S307, is one example of a first selection portion. At step S202, the main control portion 81 selects whether or not to cause the image forming portion 4 to execute the printing process in accordance with the printing condition in the registered condition information D1, depending on whether or not the time point before the start of printing is within the enabling period in the valid period information D2.

With the present embodiment, the period in which the printing process based on the registered condition information D1 is to be enabled or disabled can be set in advance based on the valid period information D2. Thus, the degree of freedom for applying the registered condition information D1 increases.

In addition, the main control portion 81 that executes the processes at steps S301 to S306 is one example of an enabling period revision portion configured to extend or shorten the enabling period represented by the valid period information D2. As previously described, the main control portion 81 extends or shortens the enabling period represented by the valid period information D2 depending on whether or not the feeding status of the sheet material 9 from the sheet receptacle 21 of the second sheet feeding portion 2b satisfies the predetermined extension condition or shortening condition.

With the present embodiment, the period in which the registered condition information D1 is enabled can be shortened or extended flexibly in accordance with the use status of the image forming apparatus 10 by the user. As a result, the degree of freedom for applying the registered condition information D1 further increases.

In addition, the main control portion 81 that executes the process at step S302 is also one example of the valid user information acquisition portion configured to acquire the valid user information from the storage portion 812 that stores the valid user information in advance. As previously described, the valid period information D2 in which “Nil” can be set as the enabling period information D21 is one example of the valid user information.

Furthermore, the main control portion 81 that executes the process at step S202, i.e., the processes at steps S301 to S307, is also one example of a second selection portion. At step S202, the main control portion 81 selects whether or not to cause the image forming portion 4 to execute the printing process in accordance with the printing condition in the registered condition information D1, depending on whether the user authentication information D00 obtained via the authentication information input portion 800 is information representing the enabled user or information representing the disabled user in the valid user information.

With the present embodiment, one part of the users can be set as subjects for an exception process, and the degree of freedom for applying or not applying the registered condition information D1 increases.

### APPLICATION EXAMPLE

In each of the embodiments shown above, the main control portion 81 of the image forming apparatus 10 conceivably sets the registered condition information D1 in accordance with an operation performed with respect to the operation display portion 80, and executes a condition registration process of causing the storage portion 812 to store the registered condition information D1.

In addition, in the condition registration process, the main control portion 81 conceivably can execute a sheet-size information automatic setting process when setting the feeding sheet-size information D11 in the registered condition information D1. The sheet-size information automatic setting process is a process of setting, as the feeding sheet-size information D11, the size information of the sheet material 9 specified from the sensing results of the sheet size sensor 801. As a result, even when the user does not have the knowledge regarding the size of the sheet material 9, the proper feeding sheet-size information D11 is set by simply placing the sheet material 9 on the sheet receptacle 21.

In each of the embodiments, one or both of the registered condition information D1 and the valid period information D2 are conceivably stored in a storage portion of another apparatus that is communicable with the image forming apparatus 10. In this case, the main control portion 81 of the image forming apparatus 10 acquires one or both of the registered condition information D1 and the valid period information D2 from the other apparatus through a communication line.

The image forming apparatus according to the present disclosure can be configured by freely combining the embodiments and application examples described above, or modifying or partially omitting the embodiments and the application examples as appropriate, within the scope of the invention recited in each claim.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming apparatus comprising:
a sheet size sensing portion configured to sense a size of a sheet material placed on a sheet receptacle;
an image forming portion configured to execute a printing process of forming an image on the sheet material fed from the sheet receptacle;
a registered condition information acquisition portion configured to acquire registered condition information, representing a correspondence relationship between the size of the sheet material and a printing condition, from a non-transitory computer-readable first storage portion configured to store the registered condition information in advance; and
a printing control portion configured to cause the image forming portion to execute the printing process in accordance with the printing condition corresponding to the size sensed by the sheet size sensing portion in the registered condition information.

2. The image forming apparatus according to claim 1, further comprising:
a valid period information acquisition portion configured to acquire valid period information, representing an enabling period during which printing based on the registered condition information is enabled, from a second non-transitory computer-readable storage portion that stores the valid period information in advance; and
a first selection portion configured to select whether or not to cause the image forming portion to execute the printing process in accordance with the printing condition in the registered condition information, depending on whether or not a time point before printing starts is within the enabling period in the valid period information.

3. The image forming apparatus according to claim 2, further comprising an enabling period revision portion configured to extend or shorten the enabling period in the valid period information, depending on whether or not a feeding status of the sheet material from the sheet receptacle satisfies a predetermined extension condition or shortening condition.

4. The image forming apparatus according to claim 1, further comprising:
an input portion configured to input user identification information;
a valid user information acquisition portion configured to acquire valid user information, including the user identification information and representing a user for which printing based on the registered condition information is enabled or disabled, from a non-transitory computer-readable third storage portion that stores the valid user information in advance; and
a second selection portion configured to select whether or not to cause the image forming portion to execute the printing process in accordance with the printing condition in the registered condition information, depending on whether the user identification information obtained through the input portion is information representing the enabled user or information representing the disabled user in the valid user information.

5. The image forming apparatus according to claim 1, further comprising
an input portion configured to input user identification information, wherein
the registered condition information acquisition portion is configured to acquire, from the first storage portion that stores the registered condition information representing the correspondence relationship between the size of the sheet material and the printing condition for each one of the user identification information, the registered condition information corresponding to the user identification information obtained through the input portion.

6. The image forming apparatus according to claim 1, further comprising
a size change determination portion configured to determine presence or absence of any changes in a size sensed by the sheet size sensing portion, every time the sheet material is fed from the sheet receptacle to the image forming portion, wherein
the printing control portion is configured to, every time the size sensed by the sheet size sensing portion changes, cause the image forming portion to execute the printing process in accordance with the printing condition corresponding to the sensed size that has been changed.
